(19) United States
(12) Patent Application Publication
(10) Pub. No.: US 2026/0072663 A1
(43) Pub. Date: Mar. 12, 2026

(54) CAPABILITY-BASED AFFINITY IN A CLUSTERED ENVIRONMENT

(71) Applicant: Hewlett Packard Enterprise Development LP, Spring, TX (US)

(72) Inventors: Pradeep Kumar Achi Vasudevan, Bangalore (IN); Ayush Sinha, Bangalore (IN)

(21) Appl. No.: 18/976,451

(22) Filed: Dec. 11, 2024

(30) Foreign Application Priority Data
Sep. 12, 2024 (IN) 202441070192

(51) Int. Cl. G06F 8/60; G06F 9/50

(52) U.S. Cl. CPC G06F 8/60; G06F 9/5044

(57) ABSTRACT

In certain examples, a method includes obtaining an app policy comprising an application match condition and a node match condition corresponding to a node capability; assessing nodes of a clustered environment to identify a node matching the node match condition; generating, by a node manager, a node label corresponding to the node capability; associating the node label with the node identified as matching the node match condition; receiving, by an application manager, an alert that an application is to be deployed; assessing, by the application manager, the application to determine that the application matches the application match condition; updating, by the application manager, an application specification of the application to include the node label as a node selection parameter; and deploying at least a portion of the application to the node based on the node label of the node selection parameter matching the node label associated with the node.

### BACKGROUND

Computing devices may be used as part of a clustered environment. In some scenarios, the computing devices of a clustered environment may be heterogeneous, thus having differing capabilities, configurations, and the like. Applications are often deployed in such clustered environments.

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims. Aspects of the present disclosure are best understood from the following detailed description when read with the accompanying figures. For a more complete understanding of this disclosure, and advantages thereof, reference is now made to the following descriptions taken in conjunction with the accompanying drawings, in which:

FIG. 1 is a block diagram of an example clustered environment, in accordance with to one or more examples disclosed herein;

FIG. 2 shows an example app policy in accordance with one or more examples disclosed herein;

FIG. 3 illustrates an overview of an example method for implementing capability-based affinity in a clustered environment, in accordance with to one or more examples disclosed herein;

FIG. 4 illustrates a block diagram of a computing device, in accordance with one or more examples disclosed herein; and

FIG. 5 illustrates a block diagram of a computing device, in accordance with one or more examples disclosed herein.

The figures are drawn to illustrate various aspects of the disclosure and are not necessarily drawn to scale.

### DESCRIPTION

The following disclosure provides many different examples for implementing different features. Specific examples of components and arrangements are described below to simplify the present disclosure. These are, of course, merely examples and are not intended to be limiting.

Orchestration systems (e.g., container orchestration systems) may deploy applications, often in clustered environments that include heterogeneous nodes, either by design or availability. Such node heterogeneity may be attributed to specific capabilities that are typically available only on a select set of nodes in a cluster. Such capabilities are often capabilities that are expensive, unique, specialized, and the like. Examples of such capabilities that only certain nodes may have include, but are not limited to, special storage devices (e.g., nonvolatile memory express solid state drives), special connectivity (e.g., connection to external network, specific virtual local area network (VLAN) connectivity, connection to particular storage, and the like), special purpose hardware (e.g., accelerators such as graphics processing units (GPUs)), specific geographic location, and the like.

In certain scenarios, applications to be deployed in clustered environments, or one or more portions of such applications, may require access to, and thus deployment on, nodes having particular capabilities. In some instances, container orchestration systems, (e.g., Kubernetes®) allow a user or system to set specific tags or labels that identify such nodes, and help place applications on the specific nodes that have the required capabilities. However, such schemes often have a variety of limitations. Examples of such limitations may include, but are not limited to: labeling of nodes is usually a manual process, requiring prior knowledge of the nodes and key values of capability labels provided by a container orchestration system; issues may be caused by migration between clusters, especially if providers (e.g., cloud providers) are different; and/or certain capabilities may not have a label or tag provided by a container orchestration system, necessitating manual tagging of the nodes, which must be repeated when nodes are replace to avoid failures.

One or more examples disclosed herein address, at least in part, the above-described and other challenges related to deploying applications to clusters with nodes having differing capabilities where the applications being deployed, or one or more portions of such applications, require specific capabilities. In one or more examples, node capabilities may be automatically identified based on policies, nodes having certain capabilities may be labeled as such, and the application deployment process may be modified to comprehend node capabilities at the time of application deployment to avoid incorrect deployment that may lead to loss of application functionality.

In one or more examples, when a certain application, or class/type of application (e.g., load balancers), requires certain capabilities for all or any portion of the application (e.g., access to an external network for a certain portion of the application), an app policy is created. Such an app policy may include match conditions for applications (e.g., name of application, class of application, type of the application, and the like), and may also include match conditions for nodes having one or more capabilities required by the application or class of applications (e.g., a regular expression match on an Internet Protocol range to indicate a node having an external network connection). Such app policies may be stored in a location accessible to a node manager, and an application manager, deployed in and/or operatively connected to a clustered environment.

In one or more examples, the node manager is configured to, from time to time (e.g., periodically, pursuant to a defined schedule, whenever a new node is added, when other node configuration changes occur, and the like), scan the app policies, and the node matching conditions therein. In one or more examples, the node manager identifies nodes matching the match condition(s) in the app policy, which are nodes having the capability required by the application. In one or more examples, the node manager then automatically generates a metadata label and associates it with the node. Any technique for creating an association between one or more nodes matching the node matching condition in the app policy (meaning the node has the required capability) and the label generated by the node manager within the clustered environment may be used without departing from the scope of examples disclosed herein. As an example, the label may be stored in a location that stores metadata associated with nodes, and that is accessible by various components deployed in a clustered environment. In one or more examples, the automated labeling of nodes having certain capabilities avoids the need for manual labeling of nodes, and ensures that node having particular capabilities are properly labeled, even as a cluster is scaled, nodes are replaced or removed, or other changes are made within the cluster.

In one or more examples, when an application is to be deployed in the clustered environment (e.g., automatically or manually using a container orchestration system), the application is often in the form of a payload of some sort that is provided to an application programming interface (API) component that is deployed in the environment, and which performs the deployment of the application in the clustered environment. In one or more examples, the application manager deployed in the clustered environment is registered with the API component, and a webhook is created so that any time an application deployment is attempted, the webhook causes a call to the application manager before the application is deployed by the API component.

In one or more examples, when the application manager is called (e.g., alerted via a webhook), the application manager assesses the application to be deployed against the aforementioned app policies to determine if the application matches any of the defined application matching parameters in any of the application policies. If the application to be deployed does not match any app policy, the application deployment may proceed as usual. However, if the application to be deployed matches one or more of the app policies (e.g., an aspect of the application matches an application match condition in an app policy), then the application may update an application specification associated with the application. Specifically, in one or more examples, a node selector portion (e.g., one or more fields) of the application specification is added or updated by the application manager to include the node label generated by the node manager for nodes matching the node matching condition that is in the app policy that the application also matched.

Once the node selector information has been added or updated in the application specification by the application manager, the application deployment proceeds via the API component deploying the application, which will now account for the node selection by deriving the label from the application specification, and deploying appropriate portions of the application on nodes that have been previously labeled with the label by the node manager.

In one or more examples, the integration allows the node manager and application manager to work seamlessly with the existing clustered environment managers (e.g., container orchestration systems) to automatically enforce capability-based affinity for application deployments.

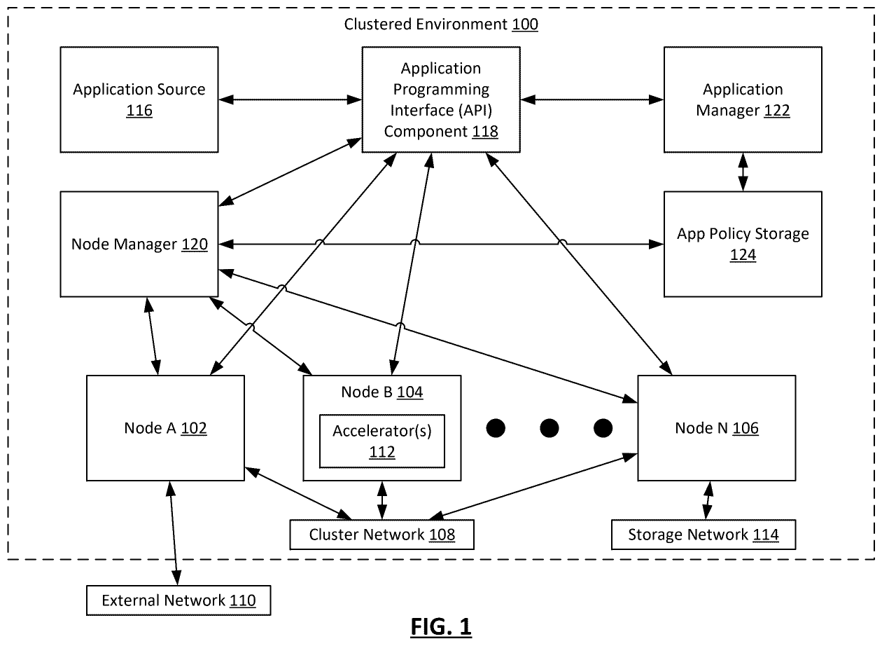

FIG. 1 is a block diagram of an example clustered environment, in accordance with to one or more examples disclosed herein. The clustered environment 100 may include any number of nodes (e.g., node A 102, node B 104, node N 106), an API component 118, a node manager 120, an application manager, and app policy storage 124. The clustered environment 100 may include and/or be operatively connected to an application source 116. Nodes (e.g., 102, 104, 106) may have differing capabilities, configurations, and/or connectivity, such as connection to an external network 110, connection to a storage network 114, and/or one or more accelerators 112. Each of these components is described below.

In one or more examples, the clustered environment 100 is any set of computing resources configured to operate, at least in part, in conjunction with one another. As an example, the clustered environment 100 may be used to implement a container system.

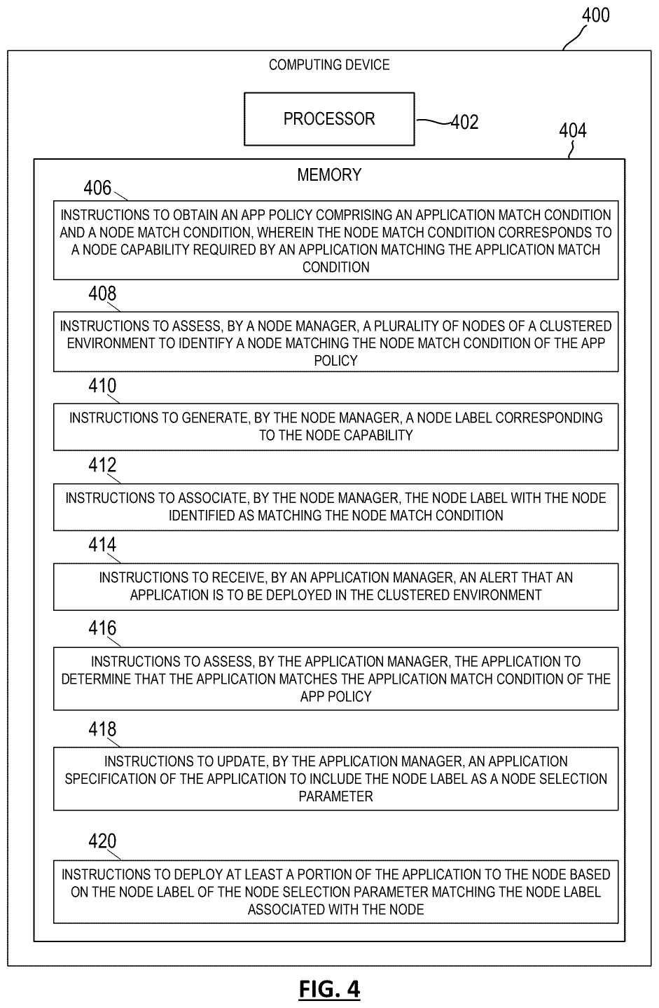

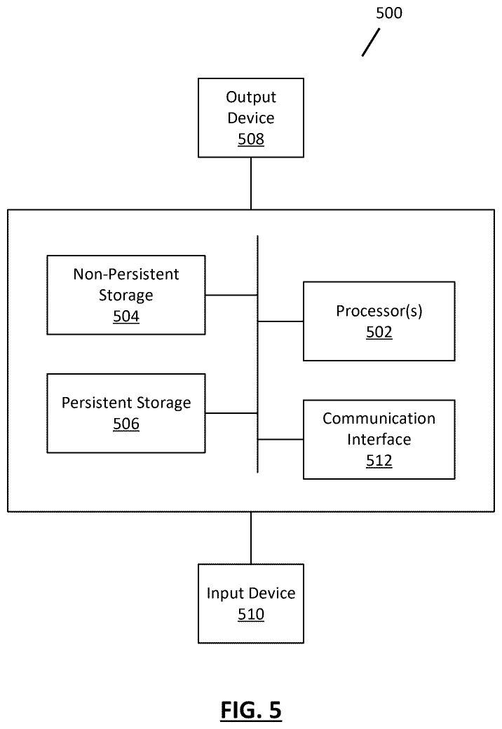

The clustered environment 100 may include any number of nodes (e.g., 102, 104, 106). In one or more examples, a node (e.g., 102, 104, 106) is a computing device. In one or more examples, as used herein, a computing device (e.g., the node A 102, the node B 104, the node N 106) may be any single computing device, a set of computing devices, a portion of one or more computing devices, or any other physical, virtual, and/or logical grouping of computing resources. Examples of a computing device are shown in FIG. 4 and FIG. 5, and described below. In one or more examples, a computing device as used herein, may be any device of any type that is configured to host all or any portion of one or more applications, microservices, clustered environment services, storage services, network services, and/or any other computing function, which may include executing instructions, performing operations, executing functions, performing computations, and the like.

In one or more examples, a computing device is any device, portion of a device, or any set of devices capable of electronically processing instructions and may include, but is not limited to, any of the following: one or more processors (e.g. components that include circuitry), memory (e.g., random access memory (RAM)), input and output device(s), non-volatile storage hardware (e.g., solid-state drives (SSDs), persistent memory (Pmem) devices, hard disk drives (HDDs) (not shown)), one or more physical interfaces (e.g., network ports, storage ports), any number of other hardware components (not shown), and/or any combination thereof.

Examples of computing devices include, but are not limited to, a server (e.g., a blade-server in a blade-server chassis, a rack server in a rack, a desktop server, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (ISCSI) storage device, a tape storage device, a flash storage array, a network attached storage device, any other type of storage device), a network device (e.g., switch, router, multi-layer switch, any other type of network device), a virtual machine, a virtualized computing environment, a logical container (e.g., for one or more applications), a container pod, an Internet of Things (IoT) device, an array of nodes of computing resources, a supercomputing device, a data center or any portion thereof, and/or any other type of computing device. As one of ordinary skill in the art will appreciate, any of the aforementioned examples of computing devices necessarily require at least some hardware components. As an example, a virtual machine, a container, and/or a container pod, when considered as a computing device herein, include the underlying hardware on which the virtual machine, container, and/or a container pod executes.

In one or more examples, the storage and/or memory of a computing device or system of computing devices may be and/or include one or more data repositories for storing any number of data structures storing any amount of data (e.g., information). In one or more examples, a data repository is any type of storage unit and/or device (e.g., a file system, database, collection of tables, RAM, hard disk drive, solid state drive, and/or any other storage mechanism or medium) for storing data. Further, the data repository may include multiple different storage units and/or devices. The multiple different storage units and/or devices may or may not be of the same type or located at the same physical location.

In one or more examples, any storage and/or memory of a computing device or system of computing devices may be considered, in whole or in part, as non-transitory computer readable mediums storing software and/or firmware, which, when executed by one or more processors, cause the one or more processors to perform operations (e.g., execution of one or more computer programs) in accordance with one or more examples disclosed herein.

Although FIG. 1 shows an example clustered environment 100 that includes three nodes (e.g., the node A 102, the node B 104, the node N 106), the clustered environment 100 may include any number of nodes without departing from the scope of examples disclosed herein.

In one or more examples, nodes (e.g., the node A 102, the node B 104, the node N 106) of the clustered environment may be heterogeneous. In one or more examples, heterogeneous nodes are nodes that may have differing capabilities, configurations, connections, and the like, which may be collectively referred to herein as capabilities. As an example, FIG. 1 shows three nodes (e.g., the node A 102, the node B 104, the node N 106) that are each operatively connected via the cluster network 108. As used herein, a network may refer to an entire network or any portion thereof (e.g., a logical portion of the devices within a topology of devices). A network may include a datacenter network, a wide area network, a local area network, a wireless network, a cellular phone network, an InfiniBand network, and/or any other suitable network that facilitates the exchange of information from one part of the network to another (e.g., between devices connected to the network). A network may be a combination of any of the aforementioned network types. A network may be located at a single physical location or be distributed at any number of physical sites. In one or more examples, a network may be coupled with or overlap with, at least in part, the Internet.

In one or more examples, each of the nodes (e.g., the node A 102, the node B 104, the node N 106) of the clustered environment having a connection to the cluster network 108 is an example of a capability that the nodes have in common with one another. However, nodes (e.g., the node A 102, the node B 104, the node N 106) may also have different capabilities. In the example shown in FIG. 1, the node A 102 has a connection to the external network 110, the node B 104 includes one or more accelerators (e.g., GPUs and/or other specialized processing units), and the node N has a connection to a storage network. Thus, each of the node A 102, the node B 104, and the node N 106 has a capability that the other nodes of the clustered environment do not have. Such node specific capabilities are shown in FIG. 1 merely to illustrate that nodes may have differing capabilities, and examples disclosed herein should not be limited to the particular arrangement of nodes and capabilities shown in FIG. 1. In certain scenarios, there may be any portion (e.g., one or more) of the nodes of the clustered environment 100 that include a particular capability, rather than just one, as shown in FIG. 1. Additionally, node capabilities that only certain nodes may have are not limited to the examples shown in FIG. 1. As an example, in addition to connection to an external network, connection to a storage network, or being configured with one or more accelerators, one or more nodes of the clustered environment may have any other relevant capabilities, such as being configured as a member or a certain VLAN, being configured with specialized hardware components, having more or less quantity of certain components (e.g., processing cores, memory devices), being located in a certain geographic region, and the like. Nodes may have any other capabilities without departing from the scope of examples disclosed herein.

In one or more examples, the clustered environment 100 includes the API component 118. In one or more examples, the API component 118 is any hardware, or software and/or firmware executing using hardware, that is configured to provide an interface through which an entity may interact with all or any portion of the clustered environment 100 in order to configure, modify, update, and the like various aspects of the clustered environment 100. As an example, the API component 118 may be all or any portion of a computing device (described above) of the clustered environment 100. In one or more examples, one aspect of the clustered environment 100 that may be configured using the API component 118 is application deployment. As an example, a user or other entity may interact with the API component 118 when seeking to deploy an application in the clustered environment 100.

Although FIG. 1 shows the clustered environment 100 as including a single API component 118, the clustered environment 100 may include any number of API components without departing from the scope of examples disclosed herein.

In one or more examples, deploying an application in the clustered environment 100 includes, but is not limited to, determining (e.g., by the API component 118) one or more nodes (e.g., 102, 104, 106) within the clustered environment 100 to which the application, in whole or in part, will be deployed. As an example, an application may have any number of components, portions, and the like, and such portions of the application may be deployed on different nodes within the clustered environment 100, with the API component 118 determining to which nodes various portions of the application are deployed.

In one or more examples, an application to be deployed in the clustered environment 100 via the API component 118 may be provided from an application source 116. In one or more examples, the application source 116 is any repository from which information, data, packages, installation files, and the like related to an application may be obtained or otherwise derived. As an example, the application source 116 may be all or any portion of a computing device (described above). In the example shown in FIG. 1, the application source 116 is shown as part of the clustered environment 100. However, examples disclosed herein are not limited to such a configuration, as the application source 116 may instead be separate from and operatively connected to one or more components, devices, nodes, and the like of the clustered environment. As an example, the application source 116 may be a third-party application provider outside of the clustered environment 100 to which the API component 118 has an operative connection.

Although FIG. 1 shows the clustered environment 100 as including a single application source 116, the clustered environment 100 may include and/or be operatively connected to any number of application sources without departing from the scope of examples disclosed herein.

In one or more examples, an application (e.g., provided as a package from the application source 116) may include, be associated with, or otherwise correspond to an application specification. In one or more examples, an application specification is a set of details (e.g., included in a file such as a YAML or JSON file) related to an application, including details related to deployment of the application. Examples of such details may include, but are not limited to, an identification of files (e.g., software images packages, libraries, and the like) of the application, how many instances of the application or portions thereof should be deployed, resource requirements, environment variables, and/or any other information relevant to an application. In one or more examples, an application specification may include, or be updated to include, node selector information. In one or more examples, node selector information is any information (e.g., included in a field, as a key-value pair, and the like) that designates one or more particular nodes on which all or any portion of an application should be deployed. In one or more examples, node selector information in an application specification may be referred to as a node selection parameter. As an example, when deploying an application, the API component 118 may be configured to assess the application specification corresponding to the application, at least in part, to determine if the application specification includes one or more node selection parameters. In one or more examples, if such a node selection parameter is included in the application specification, the API component 118 may use the node selection parameter to identify one or more nodes (e.g., 102, 104, 106) of the clustered environment 100 to which all or any portion of the application will be deployed.

In one or more examples, the clustered environment 100 includes the app policy storage 124. In one or more examples, the app policy storage 124 is any device, component, and the like configured to store one or more app policies, which may be stored using any number of data structures of any type. As an example, the app policy storage 124 may be all or any portion of a computing device (described above). Although FIG. 1 shows the app policy storage 124 as being a separate component within the clustered environment 100, the app policy storage 124 may alternatively be part of any other component of the clustered environment (e.g., the application manager 122, the node manager 120, the API component 118, and the like).

In one or more examples, an app policy is a data item of any type (e.g., a file) that includes, but may not be limited to, information related to an application, class of application, type of application, and the like, as well as additional information related to node capabilities that an application may require to function as intended. In one or more examples, when a certain application, or class of application (e.g., load balancers), requires certain capabilities for portions of the application (e.g., access to an external network for a certain portion of the application), an app policy is created, and stored in the app policy storage 124. Such an app policy may include match conditions for applications (e.g., name of application, class of application, and the like) and match conditions for nodes having the capability required by the application or class of applications (e.g., a regular expression match on an Internet Protocol range to indicate a node having an external network connection). Such app policies may be stored in the app policy storage 124 and made accessible to the node manager 120 and the application manager 122 deployed in and/or operatively connected to a clustered environment 100.

Although FIG. 1 shows the clustered environment 100 as including a single app policy storage 124, the clustered environment 100 may include and/or be operatively connected to any number of app policy storages without departing from the scope of examples disclosed herein.

In one or more examples, the clustered environment 100 includes the node manager 120. In one or more examples, the node manager is any hardware, or software and/or firmware executing on hardware, that is configured to perform various tasks related to management of the nodes (e.g., 102, 104, 106) of the clustered environment 100. As an example, the node manager 120 may be all or any portion of a computing device (described above). The node manager 120 may be operatively connected to the app policy storage 124, the API component 118, any number of nodes (e.g., 102, 104, 106), and/or any other device or component if the clustered environment 100.

In one or more examples, the node manager 120 is configured to have access to, or the ability to ascertain, information about the nodes (e.g., 102, 104, 106) of the clustered environment 100, including the capabilities of the nodes. As an example, node configuration metadata may be stored within the clustered environment, and such node configuration information may be accessible by the node manager 120.

In one or more examples, the node manager 120 is configured to, from time to time (e.g., periodically, pursuant to a defined schedule, whenever a new node is added, when other node configuration changes occur, whenever a new app policy is added to the app policy storage 124, and the like), scan the app policies in the app policy storage 124, and, more specifically, the node matching conditions included in the app policies. In one or more examples, the node manager 120 is configured to identify nodes matching the match condition in an app policy, which are nodes having the capability required by the application for which the app policy was created. In one or more examples, the node manager 120 then automatically generates a metadata label and associates it with the node. In one or more examples, a metadata label generated by the node manager 120 may be any form of information (e.g., “app-policy.kit.io: metallb-placement”) that can be used to identify a node that matches a match condition in an app policy. In one or more examples, the node manager 120 assigns the generated label to all nodes (e.g., 102, 104, 106) of the clustered environment 100 that match the match condition in an app policy, meaning the node has the capability required by all or any portion of an application to be deployed in the clustered environment 100.

Any technique for creating an association between one or more nodes matching the node matching condition in the app policy (meaning the node has the required capability) and the label generated by the node manager 120 within the clustered environment 100 may be used without departing from the scope of examples disclosed herein. In one or more examples, the automated labeling of nodes having certain capabilities avoids the need for manual labeling of nodes, and ensures that node having particular capabilities are properly labeled, even as a cluster is scaled, nodes are replaced or removed, or other changes are made within the cluster.

Although FIG. 1 shows the clustered environment 100 as including a single node manager 120, the clustered environment 100 may include and/or be operatively connected to any number of node managers without departing from the scope of examples disclosed herein.

In one or more examples, the clustered environment 100 includes the application manager 122. In one or more examples, the node manager is any hardware, or software and/or firmware executing on hardware, that is configured to perform various tasks related to determining whether an application to be deployed in the clustered environment 100 has a corresponding app policy in the app policy storage 124, and, if so, updating an application specification corresponding to the application. As an example, the application manager 122 may be all or any portion of a computing device (described above). The application manager 122 may be operatively connected to the app policy storage 124, the API component 118, and/or any other device or component if the clustered environment 100.

In one or more examples, when an application is to be deployed in the clustered environment 100 (e.g., automatically or manually using a container orchestration system), the application is often in the form of a payload of some sort that is provided to or otherwise obtained by the API component 118, which performs the deployment of the application. In one or more examples, the application manager 122 is registered with the API component 118, and a webhook is created so that any time an application deployment is attempted, the webhook causes a call to the application manager 122 before the application is deployed by the API component 118. In one or more examples, when the application manager 122 is called (e.g., via a webhook), the application manager 122 assesses the application to be deployed against the aforementioned app policies to determine if the application matches any of the defined application matching parameters in any of the app policies. In one or more examples, if the application to be deployed does not match any app policy, the application deployment may proceed without any further actions performed by the application manager 122. However, in one or more examples, if the application to be deployed matches an application match condition of one or more of the app policies, then the application may update an application specification (discussed above) associated with the application. Specifically, in one or more examples, a node selector portion (e.g., one or more fields) of the application specification is added to or updated by the application manager 122 to include the node label generated by the node manager 120 for nodes (e.g., 102, 104, 106) matching the node matching condition that is in the app policy that the application also matched.

Although FIG. 1 shows the clustered environment 100 as including a single application manager 122, the clustered environment 100 may include and/or be operatively connected to any number of application managers without departing from the scope of examples disclosed herein.

In one or more examples, once the node selector information in the application specification has been added to or updated by the application manager 122, the application deployment may proceed via the API component 118 deploying the application, and the deployment will now account for the node selection by deriving the label from the application specification, and deploying appropriate portions of the application on nodes that have been previously labeled with the label by the node manager 120.

While FIG. 1 shows a particular configuration of components, other configurations may be used without departing from the scope of examples described herein. For example, any of the components of FIG. 1 may be grouped in sets of one or more components which may exist and execute as part of any number of separate and operatively connected devices. As another example, a single component may be configured to perform all, or any portion of the functionality performed by the all or any portion of the components shown in FIG. 1. Accordingly, examples disclosed herein should not be limited to the configuration of components shown in FIG. 1.

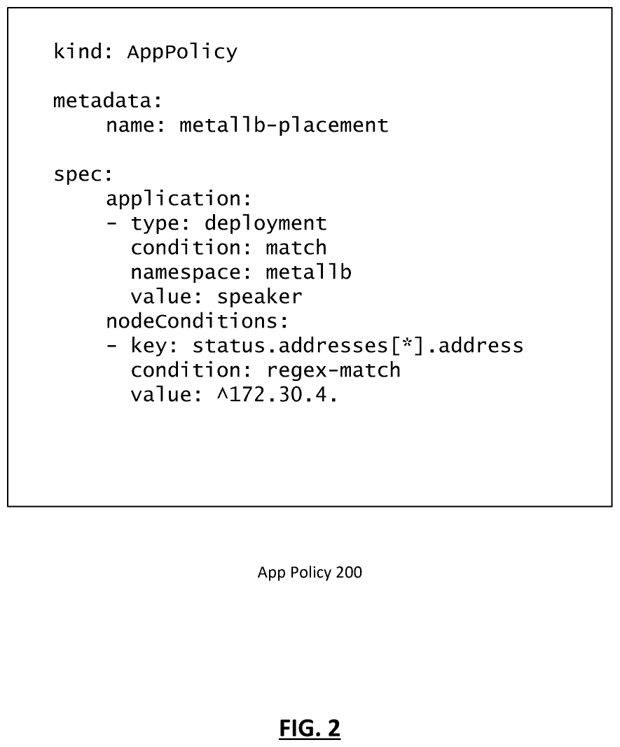

FIG. 2 shows an example app policy 200 in accordance with one or more examples disclosed herein. The app policy 200 may, for example, be created (e.g., by a system administrator) and stored in an app policy storage (e.g., the app policy storage 124 of FIG. 1), from which the app policy 200 is accessible by at least a node manager (e.g., the node manager 120 of FIG. 1) and an application manager (e.g., the application manager 122 of FIG. 1) in a clustered environment (e.g., the clustered environment 100 of FIG. 1).

The example app policy 200 shown in FIG. 2 and discussed below is a simplified example intended for explanatory purposes only, and not intended to limit the scope of examples described herein. Additionally, while the example app policy 200 shows certain aspects of examples disclosed herein, all possible aspects of such examples may not be illustrated in this particular example. One of ordinary skill in the art will appreciate that any of the aspects of the example app policy 200 shown in FIG. 2 may be different, include more or less information, use match conditions of any type, and the like.

As shown in FIG. 2, the app policy 200 is identified as such in the first line of the app policy “kind: AppPolicy”. The app policy 200 may be given a name, shown in FIG. 2 as “name: metallb-placement” in the “metadata:” section of the app policy 200. The app policy 200 includes a “spec:” section, which includes application match conditions and node match conditions.

In one or more examples, the “application:” section of the “spec:” section of the app policy 200 includes a type of action to which the app policy 200 pertains (e.g., type: deployment), which indicates when the app policy will be relevant (e.g., in the event of an application deployment).

In one or more examples, the “application:” section of the “spec:” section of the app policy 200 includes a condition (e.g., condition: match), which indicates that for the app policy to apply to a deployment, one or more of the other values in the “application:” section must match, such as namespace: metallb and/or value: speaker. In one or more examples, an application to be deployed in a clustered environment (e.g., the clustered environment 100 of FIG. 1) has a metadata label associated with it, which may be used by an application manager to match against a value (e.g., namespace:) in the app policy 200. In this particular example, the app policy includes a namespace: value of metallb. MetalLB is a load balancing application, which may be deployed as part of a container system implemented within a clustered environment. The “application:” section of the app policy may also include other values, such as “value: speaker”, which may, for example, identify one or more particular components of an application that should be deployed to nodes having one or more particular capabilities, and that match the node match condition in the app policy. In one or more examples, although the example app policy 200 shown in FIG. 2 includes an application name (e.g., metallb) as part of the application match condition, other values may be used as a match condition without departing from the scope of examples disclosed herein. As an example, the app policy 200 could have included a “class:” field that indicated a class of applications, such as “load balancer”. In such a scenario, the app policy would apply to any application to be deployed that has a class identified in the application match condition.

In one or more examples, the “nodeConditions:” section of the app policy includes one or more node match conditions. As shown in FIG. 2, the app policy 200 includes a node match condition where a node match occurs when a node's IP address (e.g., obtained from an object corresponding to the node in a container orchestration system) is a regular expression match to a particular IP subnet. Such a node match condition relating to whether or not an IP address of a node is on a particular subnet may, for example, be used to identify nodes that have a connection to an external network. Although FIG. 2 shows an example node match condition related to node IP addresses, any other capability of a node may be used as a match condition without departing from the scope of examples disclosed herein. Examples of other aspects of a node that may be used in a node match condition include, but are not limited to: whether a node has accelerators (e.g., GPUs), which may be relevant for applications that will execute machine learning algorithms; the location of a node, which may be relevant if an application deployment should be limited to a particular geographic region; how many processing cores a node has; how much memory resources a node has; whether a node has a particular type of local storage installed; whether a node has access to a storage network; and the like.

In one or more examples, a node manager (e.g., the node manager 120 of FIG. 1) in a clustered environment (e.g., the clustered environment 100 of FIG. 1) may be configured to scan the app policy storage (e.g., the app policy storage 124 of FIG. 1) from time to time to assess app policies stored therein. Such a scan may be triggered for any reason, such as, for example, any time a new app policy is added, pursuant to a particular time schedule (e.g., hourly, daily, and the like), any time a node is added to a clustered environment, and/or any other relevant trigger. In one or more examples, the node manager scans the app policies to discover the node match conditions therein, and then determines whether any nodes (e.g., the nodes 102, 104, 106 of FIG. 1) match any of the node match conditions in any of the app policies. In one or more examples, when a node matches a node match condition, the node manager generates a node label for the node, which is an item of metadata that the node manager associates with the node. The node label may be associated with the node in any manner that allows an API component performing an application deployment to identify the node label during the deployment of the application. In the example shown in FIG. 2, a node manager, when scanning the app policies, will find the node match condition in the app policy 200, and generate and apply a node label to any node in the clustered environment that has an IP address in the subnet indicated in the node match condition of the app policy 200. As an example, a node manager may discover at least one node matching the node match condition, and generate and apply a label “app-policy.k8s.io: metallb-placement” to the node.

In one or more examples, when a deployment of MetalLb is initiated in the clustered environment, the deployment proceeds via an API component (e.g., the API component 118 of FIG. 1) in the environment. In one or more examples, the application manager (e.g., the application manager 122 of FIG. 1) in the clustered environment (e.g., the clustered environment 100 of FIG. 1) is registered with the API component (e.g., the API component 118 of FIG. 1), which causes any application deployment via the API component to invoke a webhook that alerts the application manager of the application deployment. Upon receipt of such an alert, the application manager may assess the application to be deployed to determine information about the application, such as the application name, or class (e.g., load balancer), which may, for example, be in the form of a label included as part of an application installation package. Such a label may be used by the application manager to determine if any app policy in the app policy storage has a match condition matching one or more labels associated with the application. In this example, the application manager may receive an alert from the API server that an application is to be deployed, and assess the application to determine the name of the application is metallb, which matches the application match condition in the app policy 200. In response to such a match, the application manager may add information (e.g., a node selection parameter) to an application specification of the application that includes the node label generated by the node manager and applied to one or more nodes of the clustered environment. As an example, the application manager may find a component name “speaker” of an application with a namespace of “metallb”, and update an application specification node selection filter (e.g., a “nodeSelector” field) in an appropriate portion of the application specification with the “app-policy.k8s.io: metallb-placement” label previously applied to a node by the node manager.

In one or more examples, once the application specification is updated as discussed above, the deployment of the application may proceed via the API component. During the deployment, the API component may assess the application specification to determine if all or any portion (e.g., the “speaker” component) should be deployed on a particular node. In this example, the API component finds that the application specification, as updated by the application manager, indicates that the “speaker” component of the metallb application should be deployed on a node associated with a node label “app-policy.k8s.io: metallb-placement”. Thus, the API component may assess the node objects associated with the nodes of the clustered environment, find the node having the label, and deploy the speaker component of the metallb application to that node.

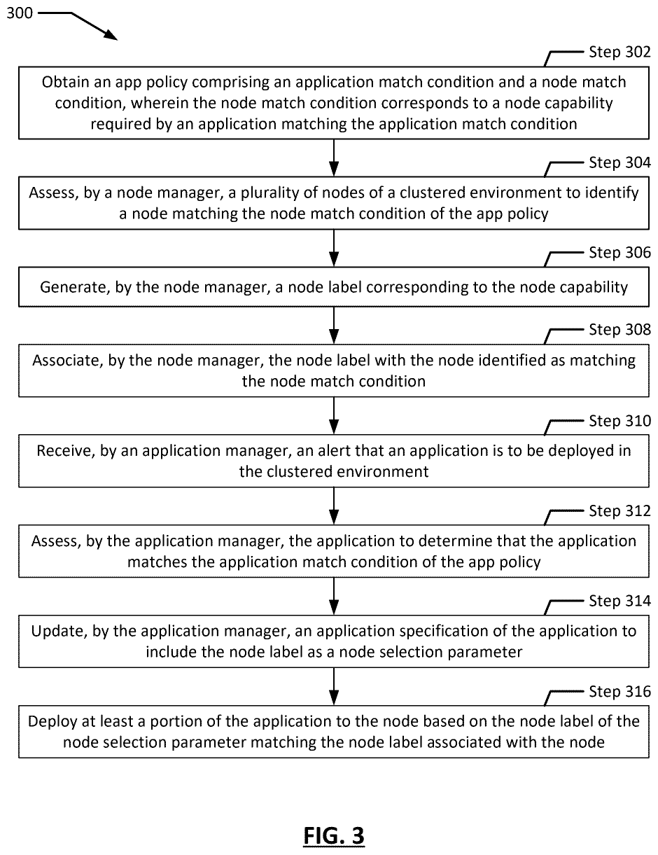

FIG. 3 illustrates an overview of an example method for implementing capability-based affinity in a clustered environment, in accordance with to one or more examples disclosed herein.

The method 300 may be performed, at least in part, by one or more devices and/or components of a clustered environment (e.g., the clustered environment 100 of FIG. 1), such as a node manager (e.g., the node manager 120 of FIG. 1), an application manager (e.g., the application manager 122 of FIG. 1), an API component (e.g., the API component 118) of FIG. 1, and the like, each of which may be all or any portion of a computing device (e.g., the computing device 400 of FIG. 4, the computing device 500 of FIG. 5).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3.

In Step 302, the method 300 includes obtaining an app policy (e.g., the app policy 200 of FIG. 2) comprising an application match condition and a node match condition, wherein the node match condition corresponds to a node capability required by an application matching the application match condition. The app policy may be stored, as an example, in an app policy storage (e.g., the app policy storage 124 of FIG. 1) of a clustered environment (e.g., the clustered environment 100 of FIG. 1).

The application match condition may be any item of information related to an application that may be ascertained by an application manager (e.g., the application manager 122 of FIG. 1) from information (e.g., a package, metadata, installation files, and the like) associated with the application, and that may also be represented in the app policy. Examples of such information include, but are not limited to, one or more of a name of an application, a name of a portion of an application, a class of an application, a type of an application, and the like.

The node match condition may be any item of information related to a capability of a node, and how a node may be identified as having such a capability. Examples of node capabilities include, but are not limited to: nodes having particular connections (e.g., to a storage network, to an external network, and the like); nodes having particular hardware (e.g., accelerators, processing cores, memory capacity, storage devices, and the like); other special attributes (e.g., being located in a certain geographic region); and/or any other capabilities a node may have that other nodes in a clustered environment may not have.

In Step 304, the method 300 includes assessing, by a node manager (e.g., the node manager 120 of FIG. 1), a plurality of nodes (e.g., the nodes 102, 104, 106 of FIG. 1) of a clustered environment (e.g., the clustered environment 100 of FIG. 1) to identify a node matching the node match condition of the app policy (e.g., the app policy 200 of FIG. 2). In one or more examples, a node manager (e.g., the node manager 120 of FIG. 1) in a clustered environment (e.g., the clustered environment 100 of FIG. 1) may be configured to scan the app policy storage (e.g., the app policy storage 124 of FIG. 1) from time to time to assess app policies stored therein. Such a scan may be triggered for any reason, such as, for example, any time a new app policy is added, pursuant to a particular time schedule (e.g., hourly, daily, and the like), any time a node is added to a clustered environment, and/or any other relevant trigger. In one or more examples, the node manager scans the app policies to discover the node match conditions therein, and then assesses nodes of a clustered environment to determine whether any nodes (e.g., the nodes 102, 104, 106 of FIG. 1) match any of the node match conditions in any of the app policies.

In Step 306, the method 300 includes generating, by the node manager (e.g., the node manager 120 of FIG. 1), a node label corresponding to the node capability. In one or more examples, when a node matches a node match condition, the node manager generates a node label for the node, which is an item of metadata that the node manager associates with the node. A node label may be any item of information that, when associated with a node of a clustered environment, allows an entity (e.g., an API component) deploying an application to identify a node as having a particular capability. The node label may or may not identify the capability. As an example, a node label may identify an app policy having a node match condition that a node matches when the node of a clustered environment has a particular capability, may include information related to the particular capability, or a combination thereof.

In Step 308, the method 300 includes associating, by the node manager (e.g., the node manager 120 of FIG. 1), the node label with the node identified as matching the node match condition of the app policy. The node label may be associated with the node in any manner that allows an API component performing an application deployment to identify the node label during the deployment of the application. As an example, a node label may be added as metadata to a node object corresponding to the node in a container orchestration system of a clustered environment.

In Step 310, the method 300 includes receiving, by an application manager (e.g., the application manager 122 of FIG. 1), an alert that an application is to be deployed in the clustered environment (e.g., the clustered environment 100 of FIG. 1). In one or more examples, when a deployment of an application is initiated in the clustered environment, the deployment may proceed, for example, via an API component (e.g., the API component 118 of FIG. 1) in the environment. In one or more examples, the application manager (e.g., the application manager 122 of FIG. 1) in the clustered environment (e.g., the clustered environment 100 of FIG. 1) is registered with the API component (e.g., the API component 118 of FIG. 1), which causes any application deployment via the API component to invoke a webhook that alerts the application manager of the application deployment.

In Step 312, the method 300 includes assessing, by the application manager, the application to determine that the application matches the application match condition of the app policy. In one or more examples, upon receipt of such an alert (as in Step 314), an application manager may assess the application to be deployed to determine information about the application, such as the application name, class (e.g., load balancer), and the like. Such information may be used by the application manager to determine if any app policy in the app policy storage has a match condition matching information associated with the application.

In Step 314, the method 300 includes updating, by the application manager (e.g., the application manager 122 of FIG. 1), an application specification of the application to include the node label as a node selection parameter. In one or more examples, an application includes and/or is associated with or otherwise corresponds to an application specification. The application specification may include various items of information that may, for example, be used by an API component when deploying the application in a clustered environment. One such item of information may be information that may be used by the API component to determine what one or more nodes on which all or any portion of an application should be installed. Such an item of information may be a node selection filter, which may be represented in an application specification as a node selection parameter (e.g., a nodeSelector field in a container ecosystem). In one or more examples, the application manager adds this field to the application specification, along with the node label previously generated by the node manager and applied to one or more nodes of the clustered environment, or updates such a field with the node label if the field already exists.

In Step 316, the method 300 includes deploying at least a portion of the application to the node based on the node label of the node selection parameter matching the node label associated with the node. In one or more examples, the application is deployed via an API component (e.g., the API component 118 of FIG. 1) of a clustered environment. In one or more examples, a particular portion, component, or the like of the application is deployed to one or more nodes to which the node label was assigned by the node manager. In one or more examples, the entire application is deployed to one or more such nodes.

FIG. 4 illustrates a block diagram of a computing device 400, in accordance with one or more examples disclosed herein. The computing device 400 is an example of the various computing devices (e.g., the node A 102, the node B 104, the node N 106, the API component 118, the node manager 120, the application manager 122 of FIG. 1) described above and/or of the computing device 500, described below. As discussed above in the descriptions of FIG. 1, FIG. 2, and FIG. 3, the computing device 400 may be used to implement all or any portion of the various components shown in FIG. 1 and described above.

The computing device 400 may include one or more processors 402 and memory 404. The memory 404 may include a non-transitory computer-readable medium that stores programming for execution by one or more of the one or more processors 402. In this implementation, one or more modules within the computing device 400 may be partially or wholly embodied as software for performing any functionality described in this disclosure. The computing device 400 may be, for example, configured to perform the method shown in FIG. 3 and described above, by executing instructions included in the memory 404 and executed by the one or more processors 402.

For example, the memory 404 may include instructions 406 to obtain an app policy comprising an application match condition and a node match condition, wherein the node match condition corresponds to a node capability required by an application matching the application match condition (e.g., as described above in reference to Step 302 of FIG. 3).

For example, the memory 404 may include instructions 408 to assess, by a node manager, a plurality of nodes of a clustered environment to identify a node matching the node match condition of the app policy (e.g., as described above in reference to Step 304 of FIG. 3).

For example, the memory 404 may include instructions 410 to generate, by the node manager, a node label corresponding to the node capability (e.g., as described above in reference to Step 306 of FIG. 3).

For example, the memory 404 may include instructions 412 to Associate, by the node manager, the node label with the node identified as matching the node match condition (e.g., as described above in reference to Step 308 of FIG. 3).

For example, the memory 404 may include instructions 414 to receive, by an application manager, an alert that an application is to be deployed in the clustered environment (e.g., as described above in reference to Step 310 of FIG. 3).

For example, the memory 404 may include instructions 416 to assess, by the application manager, the application to determine that the application matches the application match condition of the app policy (e.g., as described above in reference to Step 312 of FIG. 3).

For example, the memory 404 may include instructions 418 to update, by the application manager, an application specification of the application to include the node label as a node selection parameter (e.g., as described above in reference to Step 314 of FIG. 3).

For example, the memory 404 may include instructions 420 to deploy at least a portion of the application to the node based on the node label of the node selection parameter matching the node label associated with the node (e.g., as described above in reference to Step 316 of FIG. 3).

FIG. 5 illustrates a block diagram of a computing device, in accordance with one or more examples of this disclosure. As discussed above, examples described herein may be implemented using computing devices, and the computing device 500 shown in FIG. 5 may be such a computing device. For example, all or any portion of the components shown in FIG. 1 (e.g., the node A 102, the node B 104, the node N 106, the API component 118, the node manager 120, the application manager 122, the application source 116, the app policy storage 124) may be implemented, at least in part using a computing device such as the computing device 500, and may include all or any portion of the components of the computing device 500 shown in FIG. 5 and described below. Additionally, all or any portion of the method shown in FIG. 3 may be performed using one or more computing devices, such as the computing device 500.

In one or more examples, a computing device (e.g., the computing device 500) is any device, portion of a device, or any set of devices capable of electronically processing instructions and may include, but is not limited to, any of the following: one or more processors (e.g. components that include circuitry) (e.g., the processor 502), memory (e.g., random access memory (RAM)) (not shown), input and output device(s) (e.g., the non-persistent storage 506), non-volatile storage hardware (e.g., solid-state drives (SSDs), persistent memory (Pmem) devices, hard disk drives (HDDs) (not shown)), one or more physical interfaces (e.g., network ports, storage ports) (e.g., the persistent storage 506), any number of other hardware components (not shown), and/or any combination thereof. As used herein, a processor may be any component that can be configured to execute operations, processes, threads, and the like. In some examples, a computing device (e.g., the computing device 500) may include any number of heterogeneous processors.

The computing device 500 may include a communication interface 512 (e.g., Bluetooth interface, infrared interface, network interface, optical interface, any other type of communication interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be a central processing unit (CPU), a multi-core CPU, an application specific integrated circuit (ASIC), a graphics processing unit (GPU), a data processing unit (DPU), a tensor processing units (TPU), an associative processing unit (APU), a vision processing units (VPU), a quantum processing unit (QPU), and/or various other processing units that use special purpose hardware (e.g., field programmable gate arrays (FPGAs), System-on-a-Chips (SOCs), digital signal processors (DSPs)). Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, CAMs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not included in a drawing. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. A system, comprising:
one or more processors; and
one or more non-transitory computer readable media storing instructions which, when executed by the one or more processors, cause the one or more processors to:
obtain an app policy comprising an application match condition and a node match condition, wherein the node match condition corresponds to a node capability required by an application matching the application match condition;
assess, by a node manager, a plurality of nodes of a clustered environment to identify a node matching the node match condition of the app policy;
generate, by the node manager, a node label corresponding to the node capability;
associate, by the node manager, the node label with the node identified as matching the node match condition;
receive, by an application manager, an alert that an application is to be deployed in the clustered environment;
assess, by the application manager, the application to determine that the application matches the application match condition of the app policy;
update, by the application manager, an application specification of the application to include the node label as a node selection parameter; and
deploy at least a portion of the application to the node based on the node label of the node selection parameter matching the node label associated with the node.

2. The system of claim 1, wherein the alert is received by the application manager via a webhook of an application programming interface (API) component of the clustered environment.

3. The system of claim 2, wherein the API component is part of a container orchestration system configured, at least in part, to manage the clustered environment.

4. The system of claim 1, wherein the node capability is at least one of a network-related capability, a storage-related capability, an accelerator-related capability, and a geographic location of the node.

5. The system of claim 1, wherein the node manager is configured to assess the plurality of nodes of the clustered environment according to a node scanning schedule.

6. The system of claim 1, wherein the node manager is configured to assess the plurality of nodes of the clustered environment when a new node is added to the plurality of nodes of the clustered environment.

7. The system of claim 1, wherein the app policy is stored in a location accessible by the node manager and the application manager.

8. A computer-implemented method, comprising:
obtaining an app policy comprising an application match condition and a node match condition, wherein the node match condition corresponds to a node capability required by an application matching the application match condition;
assessing, by a node manager, a plurality of nodes of a clustered environment to identify a node matching the node match condition of the app policy;
generating, by the node manager, a node label corresponding to the node capability;
associating, by the node manager, the node label with the node identified as matching the node match condition;
receiving, by an application manager, an alert that an application is to be deployed in the clustered environment;
assessing, by the application manager, the application to determine that the application matches the application match condition of the app policy;
updating, by the application manager, an application specification of the application to include the node label as a node selection parameter; and
deploying at least a portion of the application to the node based on the node label of the node selection parameter matching the node label associated with the node.

9. The computer-implemented method of claim 8, wherein the alert is received by the application manager via a webhook of an application programming interface (API) component of the clustered environment.

10. The computer-implemented method of claim 9, wherein the API component is part of a container orchestration system configured, at least in part, to manage the clustered environment.

11. The computer-implemented method of claim 8, wherein the node capability is at least one of a network-related capability, a storage-related capability, an accelerator-related capability, and a geographic location of the node.

12. The computer-implemented method of claim 8, wherein the node manager is configured to assess the plurality of nodes of the clustered environment according to a node scanning schedule.

13. The computer-implemented method of claim 8, wherein the node manager is configured to assess the plurality of nodes of the clustered environment when a new node is added to the plurality of nodes of the clustered environment.

14. The computer-implemented method of claim 8, wherein the app policy is stored in a location accessible by the node manager and the application manager.

15. A non-transitory computer-readable medium storing programming for execution by one or more processors, the programming comprising instructions to:
obtain an app policy comprising an application match condition and a node match condition, wherein the node match condition corresponds to a node capability required by an application matching the application match condition;
assess, by a node manager, a plurality of nodes of a clustered environment to identify a node matching the node match condition of the app policy;
generate, by the node manager, a node label corresponding to the node capability;
associate, by the node manager, the node label with the node identified as matching the node match condition;
receive, by an application manager, an alert that an application is to be deployed in the clustered environment;
assess, by the application manager, the application to determine that the application matches the application match condition of the app policy;
update, by the application manager, an application specification of the application to include the node label as a node selection parameter; and
deploy at least a portion of the application to the node based on the node label of the node selection parameter matching the node label associated with the node.

16. The non-transitory computer-readable medium of claim 15, wherein:
the alert is received by the application manager via a webhook of an application programming interface (API) component of the clustered environment, and
wherein the API component is part of a container orchestration system configured, at least in part, to manage the clustered environment.

17. The non-transitory computer-readable medium of claim 15, wherein the node capability is at least one of a network-related capability, a storage-related capability, an accelerator-related capability, and a geographic location of the node.

18. The non-transitory computer-readable medium of claim 15, wherein the node manager is configured to assess the plurality of nodes of the clustered environment according to a node scanning schedule.

19. The non-transitory computer-readable medium of claim 15, wherein the node manager is configured to assess the plurality of nodes of the clustered environment when a new node is added to the plurality of nodes of the clustered environment.

20. The non-transitory computer-readable medium of claim 15, wherein the app policy is stored in a location accessible by the node manager and the application manager.
